(19) United States
(12) Patent Application Publication
(10) Pub. No.: US 2002/0077391 A1
(43) Pub. Date: Jun. 20, 2002

(54) Fibers for tire sealant composition

(76) Inventor: Robert P. McInnes, Briney Breezes, FL (US)

Correspondence Address: Alvin S. Blum, 2350 Del Mar Place, Fort Lauderdale, FL, 33301, US

(21) Appl. No.: 09/736,703

(22) Filed: Dec. 15, 2000

(51) Int. Cl. C08K 7/00; C08K 3/18; C08K 3/34

(52) U.S. Cl. 524/13; 524/430; 524/492

(57) ABSTRACT

A tire sealant composition and fibers for use in tire sealant compositions include ceramic fibers composed mainly of alumina and silica, polyethylene fibers and cellulosic fibers. The sealant is of the type to be injected into pneumatic tires to seal future punctures.

### BACKGROUND OF THE INVENTION

This invention relates to compositions to be injected into motor vehicle pneumatic tires that will seal accidental punctures and to processes for making same.

### DESCRIPTION OF THE PRIOR ART

When motor vehicle tires are accidentally punctured, the actual puncture may be easily repaired. However, the puncture and loss of tire pressure may not be noticed until the vehicle has continued a considerable distance on the at least partially deflated tire. Such travel may cause great further damage, shortening or ending its useful life. Some tires are manufactured with a layer of sealant laminated to the interior surface of the tire, as exemplified by U.S. Pat. No. 4,216,812 issued Aug. 12, 1980 to Boume; U.S. Pat. No. 5,085,942 issued Feb. 4, 1992 to Hong; and U.S. Pat. No. 4,539,344 issued Sep. 3, 1995 to Van Omum. U.S. Pat. No. 5,124,395 issued Jun. 23, 1992 to Abramowski discloses a fluid composition to be injected into a punctured tire to seal up the puncture by coating the inside with a latex material or a polyvinyl acetate emulsion. U.S. Pat. No. 4,501,825 issued Feb. 26, 1985 to Magyar discloses a tire sealer and inflator composition comprising a latex sealant, a resin, and cellulosic fibers in admixture with a fluorocarbon propellant/inflator. U.S. Pat. Nos. 4,337,322 and 4,588,758 issued Jun. 29, 1982 and May 13, 1986 to Jaspon disclose the use of asbestos fibers in a sealant mixture. Introduction of asbestos into the environment is not welcomed by the public, despite the low cost and stability of those fibers. The extreme physical conditions to which the composition will be exposed present a serious challenge to the stability of the mixture.

### SUMMARY OF THE INVENTION

It is accordingly an object of the invention to provide a sealant composition that may be injected into tires that will effectively seal punctures. It is another object that the composition will maintain its properties throughout the normal operating life of the tire. The composition of the invention includes a unique fiber mixture that has been found to be most effective in this application. This fiber mixture comprises fine chopped polyethylene, cellulosic, and ceramic fibers. The fiber mixture may be combined with a fluid vehicle including various components well known in the art, such as those disclosed in the above references.

### DETAILED DESCRIPTION OF PREFERRED EMBODIMENTS

The inventor has found that certain size and composition of fibers, when combined in an amount of less than six percent by weight with fluids such as those employed in the prior art, have been most successful in providing a useful tire sealant composition for injecting into pneumatic tires.

The fibers of the invention are:

Polyolefin fibers having diameters in the range of 10 to 30 micra and lengths between 0.4 and 1.5 millimeters;

Ceramic fibers having diameters in the range of 8 to 45 micra and lengths between 5 and 1.5 millimeters; and

Cellulosic fibers having diameters in the range of 15 to 25 micra.

The ceramic fibers used were a residue from the production of NUTEC thermal insulation. Their composition is primarily alumina and silica with traces of iron and titanium. Other glassy or ceramic fibers may be used as well.

The polyolefin fibers used were polyethylene. Other polyolefins such as polypropylene, or mixtures may be used as well.

The fibers in a combination of 48% ceramic, 20% cellulosic, and 32% polyethylene, for example, have been found successful when suspended in 95% by weight fluid.

The fluid medium in which one or more of the above fibers are suspended may be selected from the various fluids well known in the art, including:

Ethylene glycol; latex, polyvinyl acetate, water, polyethylene glycol, hydrocarbon process oil, - - - .

The above disclosed invention has a number of particular features which should preferably be employed in combination, although each is useful separately without departure from the scope of the invention. While I have shown and described the preferred embodiments of my invention, it will be understood that the invention may be embodied otherwise than as herein specifically illustrated or described, and that certain changes in form and arrangement of parts and the specific manner of practicing the invention may be made within the underlying idea or principles of the invention.

What is claimed is:

1. A fiber mixture for use in a tire sealant composition, the fiber mixture comprising:
a) polyolefin fibers having diameters in the range of 10 to 30 micra and lengths between 0.4 and 2 millimeters;
b) ceramic fibers having diameters in the range of 8 to 45 micra and lengths between 5 and 1.5 millimeters; and
c) cellulosic fibers having diameters in the range of 15 to 25 micra and lengths of 1.5 to 3 millimeters.

2. The fiber mixture according to claim 1, in which the ceramic fibers are composed mainly of alumina oxide and silica.

3. A fiber mixture for use in a tire sealant composition, the fiber mixture comprising:
a) ceramic fibers having diameters in the range of 8 to 45 micra and lengths between 5 and 1.5 millimeters; and
b) cellulosic fibers having diameters in the range of 15 to 25 micra and lengths of 1.5 to 3 millimeters.

4. The fiber mixture according to claim 3, in which the ceramic fibers are composed mainly of alumina and silica.

5. A fiber component for use in a tire sealant composition, the fiber component comprising:
ceramic fibers having diameters in the range of 8 to 45 micra and lengths between 5 and 1.5 millimeters.

6. The fiber component according to claim 5, in which the ceramic fibers are composed mainly of alumina and silica.

7. The fiber mixture according to claim 1, in which the polyolefin is polyethylene.

8. A fiber mixture for use in a tire sealant composition, the fiber mixture comprising:
c) ceramic fibers having diameters in the range of 8 to 45 micra and lengths between 5 and 1.5 millimeters; and
d) polyolefin fibers having diameters in the range of 10 to 30 micra and lengths between 0.4 and 2 millimeters.

9. The fiber mixture according to claim 8 in which the ceramic fibers are composed mainly of alumina and silica.

10. The fiber mixture according to claim 8 in which the polyolefin is polyethylene.

11. A tire sealant composition comprising the fiber mixture of claim 1 in an amount of less than six percent by weight in combination with suitable fluids.
